(19) United States
(12) Patent Application Publication
(10) Pub. No.: US 2003/0135575 A1
(43) Pub. Date: Jul. 17, 2003

(54) Self-monitoring and trending service system with cascaded pipeline linking numerous client systems

(76) Inventors: Richard Marejka, Nobleton (CA); Dean Kemp, Superior, CO (US); David Haynes, Streetsville (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/184,602

(22) Filed: Jun. 27, 2002

Related U.S. Application Data
(60) Provisional application No. 60/348,950, filed on Jan. 14, 2002.
(60) Provisional application No. 60/377,127, filed on Apr. 30, 2002.

(51) Int. Cl. G06F 15/173

(52) U.S. Cl. 709/207; 709/223

(57) ABSTRACT

A data transmission method utilizing priority-based messaging and providing a storing and forwarding of delayed messages. The method includes receiving messages with an assigned priority at a forwarding relay that are examined for priority and inserted based on assigned priority into FIFO queues provided for each message priority. A file of messages of a priority is assembled and the file is placed in the priority-based queue. The highest priority message is identified and transmitted to the appropriate recipient or stored until the recipient is available or the message deliverable. A next determination of the highest priority message is made and the next message in that priority queue is transmitted. Messages of a lower priority file are sent until a higher priority message is received. Messages for transmittal upstream and downstream of the forwarding relay are received concurrently and priority queues are provided for received upstream and downstream messages.

### CROSS-REFERENCE TO RELATED APPLICATIONS

This application claims the benefit of U.S. Provisional Application No. 60/348,950, filed Jan. 14, 2002, and U.S. Provisional Application No. 60/377,127, filed Apr. 30, 2002 the disclosures of which are herein specifically incorporated in their entirety by this reference.

### BACKGROUND OF THE INVENTION

1. Field of the Invention

The present invention relates, in general, to monitoring, reporting, and asset tracking software and systems, and more particularly, to a method and system for controlling communication and service distribution in a network of client and service provider devices that utilizes a cascaded pipeline with a plurality of relays to provide a reliable store and forward mechanism with priority messaging.

2. Relevant Background

The need for effective and cost efficient monitoring and control of servers and their clients and computer network components, i.e., systems management, continues to grow at a rapid pace in all areas of commerce. There are many reasons system management solutions are adopted by companies including reducing customer and service downtime to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

There are a number of problems and limitations associated with existing system monitoring and management tools. Generally, these tools require that software and agents be resident on the monitored systems and network devices to collect configuration and operating data and to control communications among the monitored devices, control and monitoring consoles, and a central, remote service provider. Data collected on the monitored systems is displayed on the monitoring console or client node with tools providing alerts via visual displays, emails, and page messages upon the detection of an operating problem. While providing useful information to a client operator (e.g., self-monitoring by client personnel), these tools often require a relatively large amount of system memory and operating time (e.g., 1 to 2 percent of system or device processing time).

Additionally, many management systems are not readily scalable to allow the addition of large numbers of client or monitored systems. In many monitored networks or systems, intermediate or forwarding relays are provided between a monitoring service provider system and the monitored systems for transferring messages and data between the server and monitored systems. Presently, the forwarding relays are configured with memory and software to support a relatively small number of monitored systems, i.e., the ratio of monitored systems to relays is kept relatively small. With this arrangement, it is difficult to later add new monitored systems without modifying the hardware and/or software of the relays or without adding additional relays. Additionally, the volume of data and messages sent between monitored systems and the service provider server can vary significantly over time leading to congestion within the network and the delay or loss of important monitoring and control information.

Hence, there remains a need for an improved system and method for monitoring computer systems that addresses the need for scalability due to the increasing size and complexity of company or enterprise computer systems. Such a system and method would be “light” on the end user's system requiring less memory and/or processing time to provide desired monitoring and control features. Additionally, the system and method preferably would provide a reliable message and data transfer mechanism or pipeline between the monitored system and a central service provider system or server.

### SUMMARY OF THE INVENTION

The present invention provides a self monitoring and trending service system that provides a scalable solution to delivering self-service solutions including system monitoring, trend reporting, asset tracking, and asset time delta reporting. The system is capable of monitoring customer environments with thousands of systems. Briefly, the system of the invention utilizes a cascaded pipeline architecture including linked monitored relays, forwarding relays, and Internet relays. The cascaded pipeline architecture is particularly suited for scaling from a relatively small number of client or customer systems or environments up to a network having 10,000 or more systems in a customer environment to allow a single service or solution provider to effectively distribute solutions, applications, messages, and the like to the networked systems.

In the service system, the monitored relays are end node systems connected to the pipeline. The forwarding relays are linked to the pipeline and positioned downstream of the monitored relays and configured to support 1 to 500 or more end node systems or monitored relays (e.g., providing a monitored system to relay ratio of 500 to 1 or larger) by functioning to forward and fan out the delivery of self-monitoring and other tools to customers. The Internet relays are positioned downstream of the forwarding relays and are the final point within the customer environment or network. The Internet relays function to send messages and data to the service provider system. The pipeline of the service system is adapted to be a reliable store and forward mechanism with priority-based messaging. For example, in one embodiment, a message of higher priority is sent through the pipeline in the middle of a lower priority message. In this example, the lower priority message is typically temporarily suspended and transmission is resumed when messages with its priority or priority level are allowed to be sent in the pipeline.

More particularly, the invention provides a method of controlling data transmission within a self-monitoring system, and particularly within the customer's system and/or network, utilizing priority-based messaging. The method includes receiving messages with an assigned priority at a forwarding relay. Each of the received messages is examined for priority and inserted based on its assigned priority into a temporary storage having a FIFO queue for each message priority. Typically, a file corresponding to a message of a single priority is assembled and then the file is placed in the FIFO, priority-based queue. The method continues with determining the present highest priority message within the temporary storage and then transmitting this message from the forwarding relay to the appropriate recipient (such as an upstream monitored system or a downstream service provider system or relay). The method then involves a next determination of the existing highest priority message in the temporary storage and retrieving and sending the next message in the FIFO queue that has that priority. Portions (i.e., portions of a message) of a file having a lower priority may be sent until a higher priority message is received and placed in the temporary storage. At this point, the file's transmittal is interrupted for transmittal of a higher priority file and its messages and then transmittal of the lower priority is resumed once the higher priority message(s) are sent (unless additional higher priority message have been received). According to one aspect of the invention, messages for transmittal upstream and downstream of the forwarding relay are received at least partially concurrently and a temporary storage having priority queues is provided for each set of received messages. Further, transmittal of messages upstream and downstream based on priority is occurring substantially concurrently.

### BRIEF DESCRIPTION OF THE DRAWINGS

FIG. 1 illustrates a self-monitoring and trending service system according to the present invention generally showing the use of forwarding or fan-out relays to provide scalability to link a service provider system and its services to a large number of monitored systems or relays;

FIG. 2 illustrates one embodiment of a service system of FIG. 1 showing in more detail components provided within the service provider system the forwarding relay, and the monitored system or relay to provide the desired reliable and prioritized data transfer within such a service system;

FIG. 3 is a block diagram of portions of an exemplary relay, such as a forwarding relay, customer relay, Internet relay, and the like, illustrating data and command flow and message building using upstream and downstream message queues during operation of the service system of FIG. 1 or FIG. 2; and

FIG. 4 is a flow chart showing processes performed by a forwarding relay, such as the relay shown in FIG. 3, during operation of the service system of FIGS. 1 and 2.

### DETAILED DESCRIPTION OF THE PREFERRED EMBODIMENTS

The present invention is directed to a method and system of remotely providing self-monitoring and trending services to clients to allow monitoring of operation history and status and other information regarding their computer systems and networks. More specifically, a service system is provided that includes specifically configured forwarding or fan-out relays within the customer system to provide a cascaded pipeline that controls the transmission of data and/or messages between a monitored relay or system and a service provider system and allows the customer system to be readily scaled up and down in size to include hundreds or thousands of monitored systems and nodes. As will become clear from the following description, the forwarding relays provide a store and forward mechanism that functions to provide reliable messaging and in preferred embodiments, transmits received messages based on a priority scheme that facilitates effective and timely communication of messages and data based on assigned priorities (e.g., priorities assigned by transmitting devices such as the monitored systems or relays and the service provider system). In many embodiments, all relay types provide a store and forward mechanism, including the monitored system relays, the forwarding relays, and Internet relays.

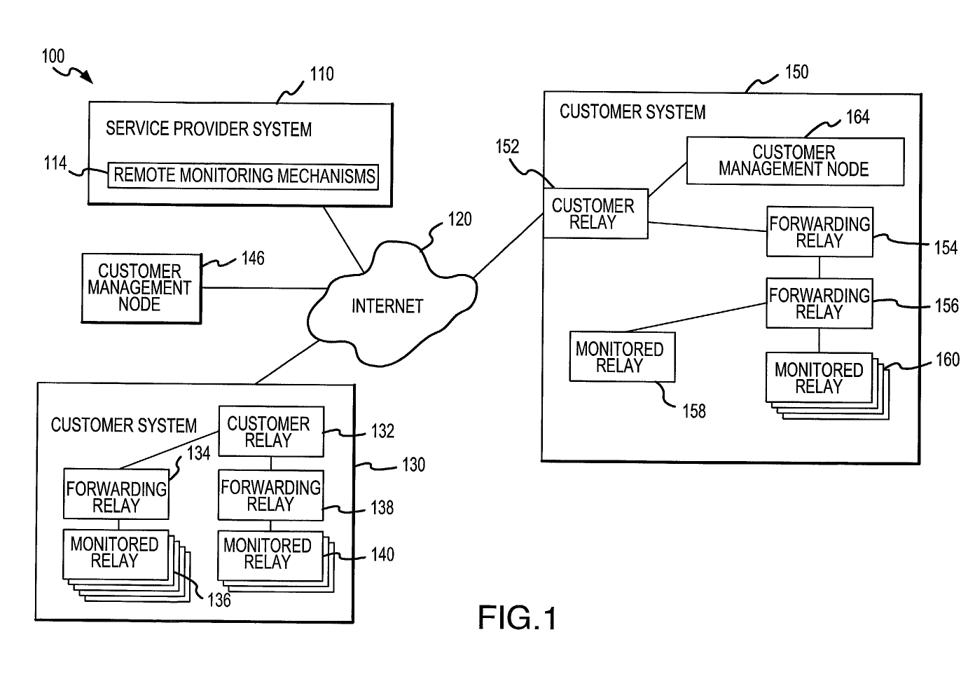

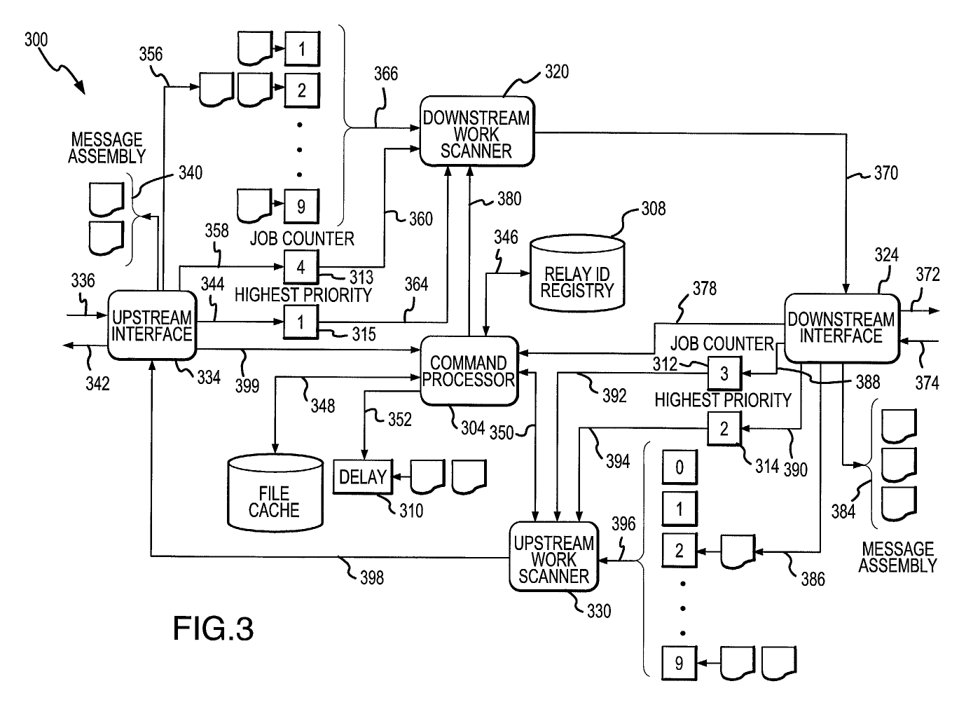

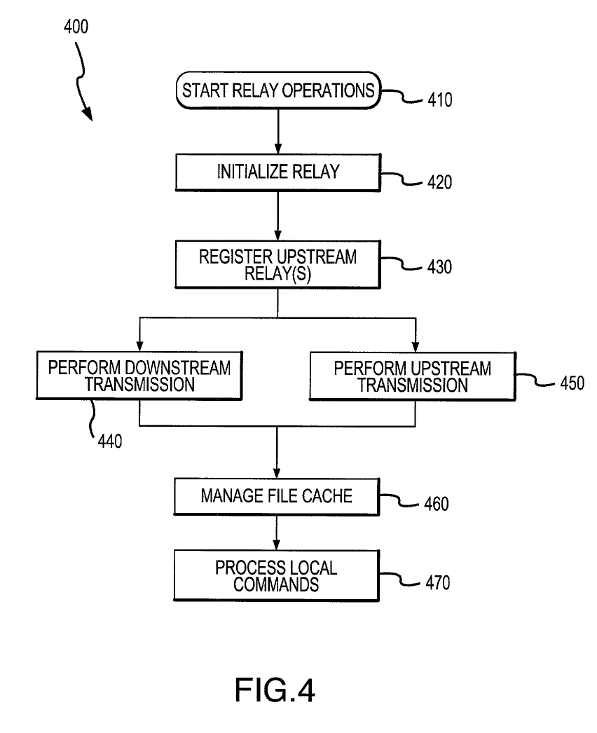

The following description begins with a discussion of a general description of a typical service system of the invention with reference to FIG. 1 and continues with a more specific description of the various components included within a service provider system, a forwarding relay, and a monitored system to provide the desired functions of the invention. Exemplary data flow within, and operation of, a forwarding relay are then described fully with reference to FIGS. 3 and 4. In most embodiments, FIG. 3 provides an accurate description of all relays in the system, such as customer system relays, Internet relays, and forwarding relays.

Referring to FIG. 1, a self monitoring and trending service system 100 is shown that according to the invention provides a scalable solution to delivering self-service solutions such as system monitoring, trend reporting, and asset tracking. The system 100 includes a service provider system 110 with remote monitoring mechanisms 114 that function to process collected data and provide event, alert, trending, status, and other relevant monitoring data in a useable form to monitoring personnel, such as via customer management nodes 146, 164. The service provider system 110 is linked to customer systems or sites 130, 150 by the Internet 120 (or any useful combination of wired or wireless digital data communication networks). The communication protocols utilized in the system 100 may vary to practice the invention and may include for example TCP/IP and SNMP. The service provider system 110 and customer systems 130, 150 (including the relays) may comprise any well-known computer and networking devices such as servers, data storage devices, routers, hubs, switches, and the like. The described features of the invention are not limited to a particular hardware configuration.

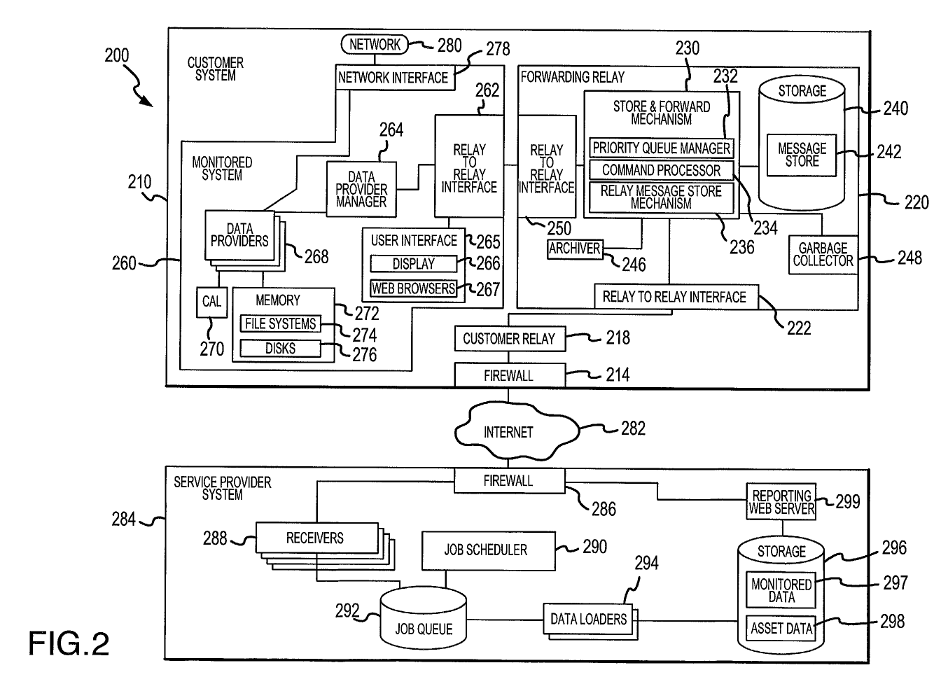

According to an important aspect of the invention, the service system 100 is adapted to provide effect data transmissions within the customer systems 130, 150 and between the service provider system 110 and the customer systems 130, 150. In this regard, the system 100 includes a cascaded pipeline architecture that includes within the customer systems 130, 150 linked customer or Internet relays 132, 152, forwarding (or intermediate or fan-out) relays 134, 138, 154, 156, and monitored relays 136, 140, 158, 160. The monitored relays 136, 140, 158, 160 are end nodes or systems being monitored in the system 100 (e.g., at which configuration, operating, status, and other data is collected). The forwarding relays 134, 138, 154, 156 are linked to the monitored relays 136, 140, 158, 160 and configured to support (or fan-out) monitored systems to forwarding relay ratios of 500 to 1 or larger. The configuration and operation of the forwarding relays 134, 138, 154, 156 are a key part of the present invention and are described in detail with reference to FIGS. 2-4. In one embodiment, the pipeline is adapted to control the transmission of data or messages within the system and the forwarding relays act to store and forward received messages (from upstream and downstream portions of the pipeline) based on priorities assigned to the messages. The customer relays 132, 152 are positioned between the Internet 120 and the forwarding relays 134, 138, 154, 156 and function as an interface between the customer system 130, 150 (and, in some cases, a customer firewall) and the Internet 120 and control communication with the service provider system 110. Of course, from an implementation perspective, there often may only be one relay with a relay configuration file defining the type of relay (e.g., monitored system, forwarding, or Internet).

The system 100 of FIG. 1 is useful for illustrating that multiple forwarding relays 134, 138 may be connected to a single customer relay 132 and that a single forwarding relay 134 can support a large number of monitored relays 136 (i.e., a large monitored system to forwarding relay ratio). Additionally, forwarding relays 154, 156 may be linked to provide more complex configurations and to allow even more monitored systems to be supported within a customer system 130, 150. Customer management nodes 146, 164 used for displaying and, thus, monitoring collected and processed system data may be located anywhere within the system 100 such as within a customer system 150 as node 164 is or directly linked to the Internet 120 and located at a remote location as is node 146. In a typical system 100, more customer systems 130, 150 would be supported by a single service provider system 110 and within each customer system 130, 150 many more monitored relays or systems and forwarding relays would be provided, with FIG. 1 being simplified for clarity and brevity of description.

FIG. 2 shows a remote monitoring service system 200 that includes a single customer system 210 linked to a service provider system 284 via the Internet 282. FIG. 2 is useful for showing more of the components within the monitored system or relay 260, the forwarding relay 220, and the service provider system 284 that function separately and in combination to provide the high monitoring system to relay ratios and the unique store and forward messaging of the present invention. As shown, the customer system 210 includes a firewall 214 connected to the Internet 282 and a customer relay 218 providing an interface to the firewall 214 and controlling communications with the service provider system 284.

According to an important aspect of the invention, the customer system 210 includes a forwarding relay 220 linked to the customer relay 218 and a monitored system 260. The forwarding relay 220 provides a number of key functions including accepting data from upstream sources and reliably and securely delivering it downstream. Throughout the following discussion, the monitored system 260 will be considered the most upstream point and the service provider system 284 the most downstream point with data (i.e., “messages”) flowing downstream from the monitored system 260 to the service provider system 284. The forwarding relay 220 accepts data from upstream and downstream sources and reliably and securely delivers it downstream and upstream, respectively. The relay 220 caches file images and supports a recipient list model for upstream (fan-out) propagation of such files. The relay 220 manages the registration of new monitored systems and manages retransmission of data to those new systems. Importantly, the forwarding relay 220 implements a priority scheme to facilitate efficient flow of data within the system 200. Preferably, each forwarding relay 220 within a service system has a similar internal structure.

The forwarding relay 220 includes two relay-to-relay interfaces 222, 250 for receiving and transmitting messages to connected relays 218, 260. A store and forward mechanism 230 is included for processing messages received from upstream and downstream relays and for building and transmitting messages. This may be thought of as a store and forward function that is preferably provided within each relay of the system 200 (and system 100 of FIG. 1) and in some embodiments, such message building and transmittal is priority based. To provide this functionality, the store and forward mechanism 230 includes a priority queue manager 232, a command processor 234, and a relay message store mechanism 236 and is linked to storage 240 including a message store 242.

Briefly, the priority queue manager 232 is responsible for maintaining a date-of-arrival ordered list of commands and messages from upstream and downstream relays. The command processor 234 coordinates overall operations of the forwarding relay 220 by interpreting all command (internal) priority messages and also acts as the file cache manager, delayed transmission queue manager, and relay registry agent (as will become more clear from the description of FIGS. 3 and 4). The relay message store mechanism 236 acts to process received message and commands and works in conjunction with the priority queue manager 232 to build messages from data in the message store 242 and to control transmission of these built messages. The mechanism 236 functions to guarantee the safety of messages as they are transmitted within the system 200 by creating images of the messages in storage 240 (e.g., on-disk images) and implementing a commit/destroy protocol to manage the on-disk images. In general, a “message” represents a single unit of work that is passed between co-operating processes within the system 200. The priority queue manager 232 functions to generate priority queues as part of the priority queue manager 232. This allows the relay 220 to obtain a date-ordered set of priority queues directly from the mechanism 230.

Generally, the message store 242 stores all messages or data received from upstream and downstream sources while it is being processed for transmittal as a new message. The store 242 may take a number of forms. In one embodiment, the store 242 utilizes a UNIX file system to store message images in a hierarchical structure (such as based on a monitored system or message source identifier and a message priority). The priority queue manager 232 implements a doubly-linked list of elements and allows insertion to both the head and tail of the list with searching being done sequentially from the head of the queue to the tail (further explanation of the “store” function of the forwarding relay 220 is provided with reference to FIGS. 3 and 4). Messages are typically not stored in the priority queue manager 232 but instead message descriptors are used to indicate the presence of messages in the message store 242. The queue manager 232 may create a number of queues such as a queue for each priority level and extra queues for held messages which are stored awaiting proper registration of receiving relays and the like. A garbage collector 248 is provided to maintain the condition of the reliable message store 242 which involves removing messages or moving messages into an archival area (not shown) with the archiver 246 based on expiry policy of the relay 220 or system 200.

In some embodiments, the forwarding relay 220 with the store and forward mechanism 230 functions to send information based upon the priority assigned (e.g., by the transmitting device such as the monitored system 260 or service provider system 284) to the message. Priorities can be assigned or adjusted based on the system of origination, the function or classification of the message, and other criteria. For example, system internal messages may be assigned the highest priority and sent immediately (e.g., never delayed or within a set time period, such as 5 minutes of posting). Alerts may be set to have the next highest priority relative to the internal messages and sent immediately or within a set time period (barring network and Internet latencies) such as 5 minutes. Nominal trend data is typically smaller in volume and given the next highest priority level. High-volume collected data such as configuration data is given lowest priority. Of course, the particular priorities assigned for messages within the system 200 may be varied to practice the prioritization features of the present invention.

The monitored system 260 typically includes components to be monitored such as one or more CPUs 270, memory 272 having file systems 274 (such as storage area networks (SANs), file server systems, and the like) and disk systems 276, and a network interface 278 linked to a customer or public network 280 (such as a WAN, LAN, or other communication network). A user interface 265 is included to allow monitoring of the monitored system 260 (e.g., viewing of data collected at the monitored system 260, processed by the service provider system 284, and transmitted back from the Reporting Web Server 299 to the user interface 265). The user interface 265 typically includes a display 266 (such as a monitor) and one or more web browsers 267 to allow viewing of screens of collected and processed data including events, alarms, status, trends, and other information useful for monitoring and evaluating operation of the monitored system 260. The web browsers 267 provide the access point for users of the user interface 265. In some embodiments, the relays are not involved with viewing of collected data and reporting web server 299, such as an HTTP server, is used (without communications via the relays as shown in FIG. 2) present the collected data via the web browser 267.

Data providers 268 are included to collect operating and other data from the monitored portions of the system 260 and a data provider manager 264 is provided to control the data providers 268 and to transmit messages to the forwarding relay 220 including assigning a priority to each message. Preferably, the data providers 268 and data provider manager 264 and the relays 220, 218 consume minimal resources on the customer system 210. In one embodiment, the CPU utilization on the monitored system 260 is less than about 0.01 percent of the total CPU utilization and the CPU utilization on the relay system is less than about 1 percent of the total CPU utilization. The data providers 268 typically collect data for a number of monitoring variables such as run queue and utilization for the CPU 270, utilization of memory 272 including information for the file systems 274 and disks 276, and collision, network errors, and deferred packets for the network interface 278. In addition to collecting monitoring variable data, the data providers 268 typically collect configuration data. The data providers 268 operate on a scheduled basis such as collecting trend data (e.g., monitoring variable information) every 10 minutes and only collecting configuration data once a week or some relatively longer period of time. The data provider manager 264 functions to coordinate collection of data by the data providers 268 and to broker the transmission of data with the relay 220.

The service provider system 284 is linked to the Internet 282 via the firewall 286 for communicating messages with the customer relay 218 and the forwarding relay 220. The service provider system 284 includes receivers 288 which are responsible for accepting data transmissions from the customer system 210 and brokering the data to the appropriate data loaders 294. Received messages or jobs are queued in job queue 292 and the job queue 292 holds the complete record of the data gathered by a provider 268 until it is processed by the data loaders 294. The job scheduler 290 is responsible for determining which jobs are run and in which order and enables loaders 294 to properly process incoming data. The data loaders 294 function to accept data from the receivers 288 and process the data into final format which is stored in storage 296 as monitored data 297 and asset data 298. The data loaders 294 are generally synchronized with the data providers 268 with, in some embodiments, a particular data loader 294 being matched to operate to load data from a particular data provider 268. The reporting web server 299 then functions to culminate all the gathered and processed data and transmit or report it to the user interface 265. The types of reports may vary but typically include time-based monitoring data for trend analysis, system configuration data for system discovery and planning, and time-based monitoring data evaluated against a set of performance level metrics (e.g., alerts) and may be in HTML or other format.

Referring now to FIG. 3, a block diagram of the internal structure 300 of a forwarding relay, such as relay 220 of FIG. 2, is illustrated to more fully describe how the relays of the invention support the fan-out and priority-based messaging functions of the invention. Each relay is connected to other relays by associating a downstream interface of one relay with the upstream relay of another, with the upstream terminus of the pipeline being the data provider manager or agent and the downstream terminus of the pipeline being the receiving agents or receivers. Relays pass messages to each other, and the messages may be of a particular type, such as “command” and “data.” Command messages are used to initiate certain actions on a target relay and data messages contain segments of information that are eventually assembled into files.

As shown, the internal relay structure 300 includes an upstream interface 334 that coordinates all data transmissions to and from the relay 300 in the upstream direction (i.e., toward the monitored system). A message arriving 336 at the upstream interface 334 may be a command or data message with some commands destined for the command processor 304 and some commands being relevant for the upstream interface 334, e.g., “start of file” and “end of file” commands. To support file transmission, upon receipt of a “start of file” command the upstream interface 334 opens a file in its message assembly area 340. The start of file command has associated with it the priority of the file being transmitted. As data segments arrive of the same priority, they are appended to the file in the file assembly area 340. When the end of file command is received, the upstream interface 334 closes the file and places it 356 on the appropriate work queue for the downstream work scanner 320 and increases the job counter 313 indicating the number of downstream jobs pending. The priority of the file being added to the downstream queues is compared against the highest priority register 315 and if the new file is of higher priority, that new priority is written to the highest priority register 315. The upstream interface 334 also receives registration command messages which are passed to the command processor 304 and upstream acknowledgement command messages which are passed to the command processor 304 for subsequent processing. The upstream interface 334 further controls the transmission throttle for upstream communications. In order not to consume all the available network bandwidth, transmitted data may be restricted to a predefined number of bytes per unit time, with the value of this restriction being a configurable and adjustable value.

The downstream work scanner 320 is provided to determine which messages are transmitted to the downstream interface 324. While the queues associated with the downstream work scanner 320 store files, the downstream work scanner 320 works with messages (with a file being composed of one or more messages). The scanner 320 begins functioning by examining the job counter 313. When the job counter 313 is not zero there is work, and the scanner 320 reads the value of the highest priority register 315. The scanner 320 then obtains the next message (e.g., start of file, data, or end of file messages) from the highest priority work queue. The scanner 320 then sends the message to the downstream interface 324, such as by a block transmission (e.g., the scanner 320 waits for the message to be received prior to scanning for new work). The use of block transmissions is desirable for supporting throttling of the downstream interface 324. The scanner 320 also implements an acknowledgement handshake protocol with the upstream interface of the downstream relay (not shown). When the downstream relay sends an acknowledgement command 374, the command is sent to the command processor 304 which routes it to the downstream work scanner 320. Upon receipt of the acknowledgement command, the scanner 320 releases the file from the work queues, decrements the job counter 313, and rescans the queues for the highest priority value.

The downstream interface 324 coordinates all transmissions to or from linked downstream relays (not shown). To allow the relay 300 to provide message transmission, the downstream interface 324, upon receipt of a message, transmits the message to the associated downstream relay. Throttling is provided by the downstream interface 324 by enforcing a limit on the amount of data that can be transmitted per unit of time. As with the upstream interface 334, the throttling value is a configurable and adjustable value or parameter. If the throttling value is exceeded, the downstream interface 324 does not read new data from the downstream work scanner 320. Once sufficient time has passed to allow new transmissions, the downstream interface 324 accepts the message from the work scanner 320 and proceeds to transmit it 372 downstream. During message reception, the interface 324 accepts messages 374 from the downstream relay (not shown) destined for the relay 300 or for upstream relays (not shown). The messages are routed in the same manner as the upstream interface 334 routes received messages but for two exceptions. First, upstream messages contain a recipient list of relay identifiers. These recipient lists have been implemented to reduce the duplication of data being transmitted to the intermediate or forwarding relays. Second, some upstream messages are actually command messages destined for upstream systems and have a priority of zero (highest priority) and a recipient list that includes upstream relay identifiers.

The upstream work scanner 330 is included to determine which messages are transmitted to the upstream interface 334 for transmittal to upstream relays (not shown). During message transmission, the scanner 330 examines the job counter 312 and when not zero, the scanner 330 reads the value of the highest priority register 314. The scanner 330 then obtains the next message (e.g., start of file, data, or end of file messages) from the highest priority work queue 396. The scanner 330 then sends the retrieved message to the upstream interface 334, such as by blocked transmission (e.g., by waiting for receipt of message prior to scanning for new work) to support throttling at the upstream interface 334. The scanner 330 implements an acknowledgement handshake protocol with the downstream interface of the immediate upstream relay 336 (not shown) and when an acknowledgement command is received from the upstream relay it is first sent to the command processor 304 and then routed to the scanner 330. Upon receipt of the acknowledgement, the scanner 330 releases the file from the work queues 396, decrements the job counter 312, and rescans the queues for the highest priority value. In some cases, it may not be possible to send a message to one or more of the upstream relays identified by the recipient list of the message. In this case, the scanner 330 passes the message to the command processor 304 for insertion in the delay queue 310. At some future time, the command processor 304 re-inserts a delayed transmission based on the registration of a recipient relay and the scanner 330 then accepts the message from the command processor 304 and re25 queues it on the appropriate priority queue.

The command processor 304 acts as the overall coordinator of operations within the relay 300 and acts as the file cache manager, the delayed transmission queue manager, and the relay registry agent. The command processor 304 handles the processing of most command messages (with the exception of start of file and end of file command messages) within the relay 300. The most commonly processed command is the file acknowledgement command that indicates that the upstream or downstream recipient relay has received a complete file. When this command is received, the command processor 304 notifies the corresponding work scanner 320 or 330 to release the file from the work queues.

The command processor 304 acts as a file cache manager and in one embodiment, acts to only cache the current version of any software or configuration files in relays 300 with no children, as the file caches of parent relays hold all the files contained in child relays due to the hierarchical nature of the pipeline. Parents of such childless relays 300 will cache the current and previous versions of any software or configuration files. Since there exists within systems according to the invention the possibility that not all designated recipients of a message will be able to receive it, the command processor 304 is configured to manage delayed transmissions without adversely affecting other message traffic. If an upstream work scanner 330 is unable to deliver a message to a recipient, the file associated with that message is passed to the command processor 304 for inclusion on its delayed transmission queue 310. The command processor 304 further acts as a relay registry agent by making a record of the relay identifier of the registrant for storage in registry 308 when an upstream relay becomes active and sends a registration message to its downstream relay. The registration command message also includes a list of all configuration and software versions associated with the upstream relay. This list is compared by the command processor 304 to the list of required versions maintained in the file cache 348. Any upgrades in software or configuration files are sent by the command processor 304 to the upstream work scanner 330 for insertion onto the appropriate queues. The delayed transmission queue 310 is then scanned to determine if there are any messages on the queue that are destined for the new registrant. If so, these messages are passed to the upstream work scanner 330 for insertion onto the appropriate queues.

Referring now to FIG. 4 with further reference to FIG. 3, several of the processes or functions performed by an operating forwarding relay (such as relay 220 of FIGS. 2 and 300 of FIG. 3) are more fully described to stress the important features of the invention. At 410 relay operations begin and the relay is initialized at 420. Initialization 420 of a relay starts with the command processor 304 and continues until the relay 300 is in a mode where it is ready to receive and transmit data with upstream relays and it is registered and ready to exchange data with downstream relays. After the command processor 304 is instantiated, the command processor 304 acts to clear 346 the relay identification registry 308. The command processor 304 then moves 352 all files that were placed upon the delayed transmission queue 310 to the upstream file queue area. The job counters 312, 313 are then reset to zero and the highest priority registers 314, 315 are set to zero.

Initialization 420 continues with starting the downstream work scanner 320 in its initialization state. In this state, the downstream work scanner 320 rebuilds the downstream job queues from images on the disk. Once the queues have been rebuilt, the downstream work scanner 320 sets the job counter 313 and the highest priority register 315 to the appropriate values. The scanner 320 then begins to process the transmission of the highest priority file on the queues. The downstream interface 324 then starts in its initialization state which causes it to issue a registration request 372 to the downstream relay. The upstream work scanner 330 is started in its initial state where it rebuilds its work queues, including those files that have been restored from the delayed transmission queue 310, and sets the job counter and the highest priority registers 312, 314 appropriately. The upstream work scanner 320 then processes the first file on the upstream work queues 396. Next, the upstream interface 334 is instantiated and conditions itself to accept connections and messages from upstream relays.

For proper pipeline communications, downstream relays need to know that an upstream relay has been initialized. In order to support this, the downstream relay processes at 430 registration requests from upstream relays. The upstream interface 334 receives a start of file command 336 and opens a file in the file assembly area 340. As additional data messages 336 are received, they are appended to the file in the file assembly area 340. When an end of file command 336 is received, the file in the file assembly area 340 is closed and the upstream interface 334 generates an acknowledgement message 342 to the upstream relay. The command file is passed 399 to the command processor 304. This file contains all the information required to register the upstream relay including a list of all configuration file versions, relay and agent versions, and provider versions.

The relay is registered 346 by the command processor 304 with the relay identification registry 308. The version information supplied by the upstream relay is compared at 348 to the configuration file information in the file cache and any deviations are noted. All deviations are corrected by transmitting 350 the new files from the cache to the upstream work scanner 330 for insertion 396 into the appropriate transmission queues. The command processor 304 then scans 352 the delayed work queue 310 to determine if any files contained on that queue 310 are destined for this newly registered relay. If delayed transmission files are found, they are passed 350 to the upstream work scanner 330 for insertion onto the appropriate work queues.

Downstream transmission at 440 encompasses the transmission of data from an upstream (customer system) source to a downstream destination (service provider system) through a relay. The relay 300 supports a store-and-forward mechanism as well as a priority messaging system to provide enhanced safe delivery of data and with acceptable timing. Transmission 440 begins with the upstream interface 334 receiving 336 a start of file command. The upstream interface 334 creates a new file in the file assembly area 340 to store the incoming file. The upstream interface 334 then receives a series of data messages 336. If the priority of the received data message matches the priority of the file 340, the data segment of the data message is appended to this file 340. The upstream interface 334 then receives an end of file command 336 at which point the interface 334 closes the file 340 and issues an acknowledgement command 342 to the upstream relay. The completed file is then added at 356 to the end of the appropriate downstream transmission work queue and the job queue counter 313 is incremented. The priority of this new file is compared 344 to the highest priority register 315 and if the new file has a higher priority, the highest priority register 315 is updated with the new, higher priority.

The downstream work scanner 320 then examines 360 the job counter register 313 to determine whether there is work pending. If work is determined to be pending, the scanner 320 obtains the value of the highest priority register 315. The file at the head of the highest priority queue is then accessed 366 and if there is no more work on this queue, the next queue is accessed and the highest priority register 315 is adjusted (decremented). If there is work on this queue but no open file, then a file is opened and the downstream work scanner or processor 320 issues a start of file command. If there is an open file, the next segment of the file is obtained by the scanner 320. If there is no more data in the file, the downstream work scanner 320 closes the file and issues an end of file command and a status of “waiting for acknowledgment” is set on the file. The message containing the command or data segment is transmitted 370 to the downstream interface 324 (e.g., as a blocked I/O operation). The downstream interface 324 accepts the message and transmits 372 it to the downstream relay. Once the end of file message has been transmitted 372, the downstream relay responds with an acknowledgment command 374 which is passed 378 to the command processor 304. The command processor 304 then routes 380 the acknowledgement to the downstream work scanner 320 which then removes 366 the file from the downstream queues. The scanner 320 also decrements 360 the job counter 313 to reflect completion of the transmission 440.

Upstream transmission 450 deals with the transfer of data from a downstream source to an upstream relay and is similar to downstream transmissions except that upstream messages include lists of recipient systems. Preferably, the relay 300 is configured to continue to make efforts to deliver the file to each of the systems on the list and to forward command files to upstream relays (even when not yet registered). The transmission 450 begins with the downstream interface 324 receiving 374 a start of file command. The downstream interface 324 responds by creating a new file in the file assembly area 384 to store the incoming file. The downstream interface 324 then receives a series of data messages 374 and if the priority of the received data messages match the priority of this file the data segment of the received data message is appended to this file. The downstream interface 324 then receives an end of file command 374 and closes the file 384 and issues an acknowledgement command 372 to the downstream relay.

The complete file is added at 386 to the end of the appropriate upstream transmission work queue and commands destined for upstream relays are also queued. The job queue counter 312 is incremented 388 and the priority of the new file is compared 390 to the highest priority register 314. If the new file has a higher priority than the highest priority register 314, the highest priority register 314 is updated with the new, higher priority. The upstream work scanner 330 examines 392 the job counter register 312 to determine whether there is work pending and if so, the scanner 330 obtains 394 the value of the highest priority register 314. The file at the head of the highest priority queue is accessed 396 and if there is no more work on this queue, the next queue is accessed and the highest priority register 314 is adjusted. If there is work on this queue but no open file, then the file is opened and the upstream work scanner 330 issues a start of file command. If there is an open file, the next segment of the file is obtained by the scanner 330. If there is no more data in the file, the scanner 330 closes the file and issues an end of file command and a status of “waiting for acknowledgement” is set on the file.

The message containing a command or data segment is transmitted 398 to the upstream interface 334 (e.g., a blocked I/O operation). The upstream interface 334 accepts the message and transmits it 342 to the upstream relay. If the interface 334 is unable to contact the recipient, the upstream work scanner 330 is notified of the failure and the recipient is marked as “unavailable” on the recipient list. Once the end of file message has been transmitted 342, the upstream relay responds with an acknowledgement command 336 which is passed 399 to the command processor 304. The command processor 304 then routes 350 the acknowledgement to the upstream work scanner 330 which proceeds to repeat transmission steps until all recipients have been sent the file. If all recipients have received the file, the upstream scanner 330 removes the file at 396 from the upstream queues and decrements the job counter 312 to reflect the completion of the transmission. If any message is not delivered by the upstream interface 334, a copy of the file is sent 350 to the command processor 304 which stores the file 352 in the delayed transmission queue 310.

The relays act to perform file cache management at 460 which allows for the remote management of each relay's file cache. The relay has a file cache to minimize the number of transmissions that must traverse the entire pipeline. The downstream interface 324 receives a command message 374 from the downstream relay indicating the start of a cached file. The interface accepts the transmission and rebuilds the file image in the file assembly area 284. Upon receipt of the end of file command 374, the downstream interface 324 sends an acknowledgment command 372 to the downstream relay. The interface 324 then passes the command 378 to the command processor 304 which interprets the command and takes the appropriate actions upon the cache file 348, such as adding the file to the cache, removing a file from the cache, returning a list of the file cache contents, and the like. Any responses generated by the command processor 304 are sent 380 to the downstream work scanner 320 for further processing.

The forwarding relays also process local commands at 470 which are command messages addressed to the local or receiving relay. The downstream interface 324 receives a start of command message 374 and opens a file in the file assembly area 384 to hold it. Subsequent data messages are appended to the open file until an end of file command message is received 374. Then, the downstream interface 324 generates an acknowledgement message for the command file 372. The command file is then passed 378 to the command processor 304 for processing. Any responses generated by the command processor 304 for transmittal to the downstream relay or message source are passed 380 to the downstream work scanner 320 for further processing. In many implementations, items 430, 440, 450, 460, and 470 are performed fully or partially concurrently with appropriate synchronization and, hence, the order shown for these items is not intended to be limiting.

Due to the importance of the priority messaging function within the forwarding relays and receivers of the invention, the following further description of one embodiment of data transmission is provided. Files containing data to be sent upstream or downstream are added to the end of FIFO queues. The appropriate FIFO queue is selected based upon the priority assigned (by the sending device based on the corresponding process) to the file. In one embodiment, processes have a range of priorities spanning the priority value range (such as 1-9 with 1 being the highest priority and 9 the lowest). A special priority of zero is often reserved for use with control messages. The work scanners (or scanner processes) start looking at the FIFO queues beginning with the priority indicated in the highest priority register (or alternatively by starting each time with the highest priority FIFO queue, i.e., the zero priority queue). If a file is found, a segment or message of the file is sent to the appropriate relay interface. The work scanner then goes to the highest priority register (or directly to the appropriate queue) to determine which is presently the highest priority message to be sent. This priority messaging design allows higher priority work and messages to be processed as soon as it is received at the relay (e.g., within the next work cycle of the work scanner) and allows for the gradual transfer of lower priority, larger files that otherwise may block the pipeline (delay high priority messages).

The receiver is responsible for coordinating the reassembly of the segments or messages into a copy of the originally sent file. Similar to the forwarding relay, the receiver manages a set of priority elements but generally only has one file open for any particular priority. The receiver listens to transmissions from the pipeline and examines the priority of segments received. If there is no file associated with a segment's priority, the receiver creates a new file and adds the segment as the first element of the file. If a file already exists for the priority level, the receiver simply appends the segment to the end of the existing file. When an end of file message is received, the receiver closes the file for that priority and places the information in the job queue to indicate that the file is available for subsequent processing.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A priority-based messaging method for controlling transmission of data within a system monitoring system, comprising:
receiving messages at a forwarding relay, wherein each message has an assigned priority;
first determining a message having a highest priority based on the assigned priority;
transmitting from the forwarding relay the first-determined highest priority message;
second determining a message having a highest priority based on the assigned priority; and
transmitting from the forwarding relay the second-determined highest priority message.

2. The messaging method of claim 1, further including after the receiving, placing the received messages in queues associated with the assigned priorities.

3. The messaging method of claim 2, wherein the queues are first-in-first-out (FIFO) queues.

4. The messaging method of claim 2, further including after receipt of each of the messages, adjusting a highest priority register to a highest one of the assigned priorities of the received messages and wherein the first and second determining comprises reading the highest priority register.

5. The messaging method of claim 4, wherein one of the received messages is a start of file message, and further including opening a file in the queue associated with the assigned priority of the start of file message and wherein one of the received messages is an end of file message and further including closing the opened file with the assigned priority of the end of file message.

6. The messaging method of claim 5, wherein the first-determined highest-priority message and the second-determined highest priority message are from differing ones of the queues.

7. The messaging method of claim 1, further including receiving an acknowledgement command from a recipient of a transmitted message and in response, releasing a file in the priority queues containing the transmitted message and decrementing a job counter register.

8. The messaging method of claim 1, wherein the receiving of messages comprises receiving messages from upstream and downstream sources and wherein the first determining, the transmitting of the first-determined highest priority message, the second determining, and the transmitting of the second-determined highest priority message are performed at least partially concurrently for the upstream and downstream source messages.

9. A forwarding relay for use in a customer system portion of a self-monitoring system and positioned between monitored systems in the customer system and a communication network interface and a service provider system, comprising:
a downstream interface receiving upstream messages each comprising a recipient list and assembling the upstream messages in a message assembly area into upstream forwarding messages;
an upstream work scanner retrieving the upstream forwarding messages for transmittal to select ones of the monitored systems based on the recipient list associated with each of the retrieved messages; and
an upstream interface for transmitting the retrieved messages to the select ones of the monitored systems.

10. The relay of claim 9, further including a delayed transmission storage area and a command processor for storing delayed ones and undeliverable ones of the transmitted upstream forwarding messages in the delayed transmission storage area.

11. The relay of claim 10, wherein the command processor functions to initiate sending the stored delayed ones of the transmitted upstream forwarding messages.

12. The relay of claim 11, wherein the upstream receives a registration request for an upstream device on the recipient list associated with a stored delayed message and passes the registration request to the command processor and wherein the command processor registers the upstream device, determines if the registered upstream device is on the recipient list, and in response to the determination, transfers the stored delayed message to the upstream work scanner to initiate message transfer.

13. The relay of claim 9, wherein the upstream interface receives messages intended to be forwarded downstream and assembles the received messages in a message assembly area into messages to be forwarded downstream and further including a downstream work scanner retrieving the messages to be forwarded downstream and passing the retrieved messages to the downstream interface for transmittal to the service provider system.

14. The relay of claim 9, wherein the received upstream messages further comprise an assigned priority and further including a set of queues for storing the assembled upstream forwarding messages in first-in-first-out (FIFO) queues based on the assigned priorities.

15. The relay of claim 14, further including a highest priority register and wherein the downstream interface functions to establish a priority setting in the highest priority register based on the assigned priorities of the received upstream messages.

16. The relay of claim 15, wherein the upstream work scanner reads the priority setting of the highest priority register and performs the retrieving by obtaining a message from the FIFO queue having the read priority setting.

17. A customer-based service system for providing self-service tools from a central service provider node linked to a data communications network to customer environments via the communications network, comprising:
a communication pipeline within a customer environment adapted for digital data transfer;
a plurality of monitored relays linked to the pipeline comprising end nodes running at least a portion of the provided self-service tools;
a forwarding relay linked to the pipeline upstream of the monitored relays adapted to control flow of data transmitted between the service provider node and the monitored relays, wherein the forwarding relay includes means for storing the transmitted data and selectively forwarding the stored data on the pipeline; and
a customer relay linked to the pipeline and to the communications network providing a communication interface between the service provider node and the forwarding relay.

18. The system of claim 17, wherein the storing and forwarding means of the forwarding relay comprises priority queues for storing the transmitted data in files based on priorities associated with individual the transmitted data and an interface for processing the transmitted data received at the forwarding relay and placing the data in the priority queues.

19. The system of claim 18, wherein the storing and forwarding means further comprises a highest priority register for storing a highest priority value for the transmitted data in the priority queues and a work scanner for obtaining the highest priority value and retrieving a portion of the transmitted data from the priority queues corresponding to the highest priority value for the selective forwarding.

20. The system of claim 17, wherein the transmitted data includes upstream messages having a recipient list identifying a set of the monitored relays for receiving the transmitted data, and wherein the storing and forwarding means comprises an upstream interface for transmitting the transmitted data to registered ones of the monitored relays on the recipient list and a command processor for storing the transmitted data for non-registered ones of the monitored relays on the recipient list and for, when the non-registered ones are determined to be registered, initiating transmittal of the stored transmitted data
